(19) United States
(12) Patent Application Publication
(10) Pub. No.: US 2008/0307989 A1
(43) Pub. Date: Dec. 18, 2008

(54) Printing machine and a corresponding method

(75) Inventors: Herve Chaize, Saint Leu D'Esseurent (FR); Christophe Noiret, Saint Leu D'Esseurent (FR); Nicolas Rousseau, Cinqueux (FR)

Correspondence Address: Davidson, Davidson & Kappel, LLC, 485 7th Avenue, 14th Floor, New York, NY, 10018, US

(73) Assignee: GOSS INTERNATIONAL MONTATAIRE SA, Montataire (FR)

(21) Appl. No.: 12/156,157

(22) Filed: May 30, 2008

(30) Foreign Application Priority Data
Jun. 1, 2007 (FR) 07 55414

(51) Int. Cl. B41F 13/56

(52) U.S. Cl. 101/227

(57) ABSTRACT

A rotary printing machine including a continuous web of material to be printed, the web having two sides, and at least one printing unit designed to print on the web. It includes a powdering device, designed to deposit powder on at least one of the two sides of the web printed by the printing unit. For use in magazine printing presses.

This claims the benefit of French Application 0755414 filed on Jun. 1, 2007, the entire specification of which is hereby incorporated by reference herein.

The present invention relates to a rotary printing machine of the type comprising: a continuous web of material to be printed on, the web having two sides, and at least one printing unit designed to print on the web.

### BACKGROUND TO THE INVENTION

Patent application FR-A-2 888 527 discloses a rotary printing machine which comprises at least one printing unit provided with a pair of printing rollers, together with a cutting device designed to cut the web printed by the printing unit.

This printing machine comprises a traction device designed to apply a preset tension to the printed web downstream of the last printing unit and upstream of a device for cutting the web into sheets.

### SUMMARY OF THE INVENTION

An object of the present invention is to improve the quality of the printed products which can be produced by the printing machine, using simple means.

For this purpose, the invention proposes a printing machine of the aforementioned type, wherein it comprises a powdering device designed to deposit powder on at least one of the two sides of the web printed by the printing unit.

In specific embodiments, the printing machine may have one or more of the following features:

the printing machine also comprises a cutting device designed to cut the web printed by the printing unit into sheets, the powdering device being positioned upstream of the cutting device;

the printing machine also comprises a stacking device designed to stack the sheets formed by the cutting device;

the printing machine also comprises a traction device located downstream of the printing unit located furthest downstream and upstream of the cutting device, and the traction device is designed to apply a specified mechanical tension to the printed web emerging from the printing unit located furthest downstream;

the powdering device is positioned downstream of the traction device;

the powdering device is positioned upstream of the traction device;

the machine is designed to convey the printed web in a freely suspended way, in the ambient atmosphere for example, along the whole path between the printing unit located furthest downstream and the powdering device, and between the powdering device and the traction device;

the printing machine has a web capture device positioned directly downstream of the printing unit located furthest downstream, and it is designed to convey the printed web in the ambient atmosphere along the whole path between the printing unit located furthest downstream and the web capture device;

the machine comprises a device for drying the printed web, for example a device for drying by heating, such as an infrared heating device, positioned upstream of the powdering device;

the machine is designed to convey the printed web in the ambient atmosphere along the whole path between the traction device and the cutting device;

the traction device has two traction elements, each having a traction surface designed to contact one side of the printed web in order to apply the specified mechanical traction to this printed web;

the machine may include a device for supplying an ink-repellent liquid to at least one traction surface;

the two traction elements have ink-repellent traction surfaces;

the two traction elements are traction rollers;

the two traction rollers are positioned facing each other;

each of the two traction elements is designed to contact one of the two opposite sides of the printed web;

the traction device is provided with a device for cleaning the traction surface of at least one of the traction rollers;

the cleaning device has a cleaning bar in contact with the traction surface;

the traction elements have traction bars extending across the printed web;

the machine also has a support device positioned between the printing unit located furthest downstream and the cutting device, this support device having at least one support roller provided with a surface for supporting the printed web, and the support device has means for creating an air cushion between the support surface and the printed web;

the web is a web of coated paper;

the coated paper of the web is coated paper having a coat of kaolin or chalk;

the printing unit comprises an ink reservoir containing ink suitable for printing on the web;

the ink is waterless; and

the ink is quick-drying ink or two-component ink.

The invention also proposes a printing method of the type comprising the following steps:
a) printing on a web to form a printed web, and
b) cutting the printed web into printed sheets, characterized by the following step:
c) applying a drying powder to the printed web by means of a printing machine as defined above.

### BRIEF DESCRIPTION OF THE DRAWINGS

The invention will be more clearly understood with the aid of the following description, provided solely by way of example, which refers to the appended figures, in which:

FIG. 1 is a schematic side view of a printing machine according to the invention;

FIG. 2 is a view, corresponding to the view of FIG. 1, of a first embodiment of a printing machine according to the invention;

FIG. 3 is a perspective view of a detail of a traction device in a first embodiment of a printing machine according to the invention;

FIG. 4 is a detail view, corresponding to the view of FIG. 3, of a second embodiment of a traction device of the printing machine according to the invention;

FIG. 5 is a side view of a third embodiment of a traction device according to the invention;

FIG. 6 is a sectional view of a traction roller of a traction device in a fourth embodiment of the printing machine according to the invention;

FIG. 7 is a schematic side view of a detail of a traction device according to a fifth embodiment;

FIG. 8 is a view from above of the detail of FIG. 7;

FIG. 9 is a schematic side view of a printing machine in a second variant, comprising a support device for the printed web; and

FIGS. 10 and 11 are side views of the first and second embodiments of the support device.

### DESCRIPTION OF PREFERRED EMBODIMENTS

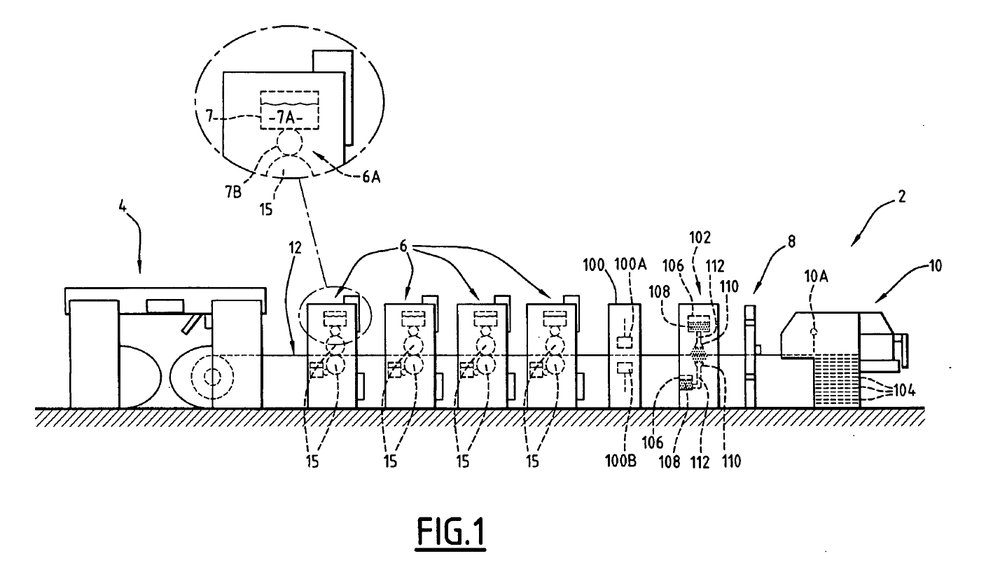

FIG. 1 shows a rotary printing machine according to the invention, indicated by the general reference 2.

The printing machine 2 comprises an unwinder 4, four printing units 6, a traction device 8 and a cutting and stacking device 10. The printing machine 2 also comprises a web capture device 100 and a powdering device 102. The printing machine 2 could theoretically have any number of printing units 6, from one to n.

Each printing unit 6 has an inking device 6A which is provided with an ink reservoir 7 containing ink 7A formulated for printing on the web 12. The ink 7A used for the purposes of the invention will be described below. Each inking device 6A also comprises an ink transfer roller 7B for transferring ink 7A to printing rollers 15 (see below).

The unwinder 4 is designed to unwind a continuous web 12.

The web 12 is a web of coated paper. Coated paper is a paper which comprises a layer of coating, for example kaolin or chalk, which improves the mechanical or optical properties of the paper. This paper enables a high-quality printed product to be obtained. In a variant, the web can be a web of uncoated paper.

The printing machine 2 provides a printing path for the web 12 from the unwinder 4, through the printing units 6, the web capture device 100, the powdering device 102, and the traction device 8, to the cutting and stacking device 10.

The printing units 6 comprise printing rollers 15 which are designed to print on the web 12.

The cutting and stacking device 10 is designed to cut the web 12 into individual sheets 104. For this purpose, the cutting and stacking device 10 has a cutting blade 10A. The cutting and stacking device 10 is also designed to produce a stack of the individual sheets 104 cut off by the blade 10A.

The traction device 8 is located downstream of the printing unit 6 which is located furthest downstream, and upstream of the cutting and stacking device 10. This traction device 8 is designed to apply a specified mechanical tension to the web 12 emerging from the printing unit 6 located furthest downstream.

As shown in FIG. 1, the printing machine 2 is designed to convey the printed web 12 in a freely suspended way and in the ambient atmosphere along the whole path between the printing unit 6 located furthest downstream and the traction device 8, except in the web capture device 100 and the powdering device 102. The printing machine 2 is also designed to convey the printed web 12 in the ambient atmosphere along the whole path between the traction device 8 and the cutting and stacking device 10. Thus the printing machine 2 has no dryer, and its overall dimensions are small.

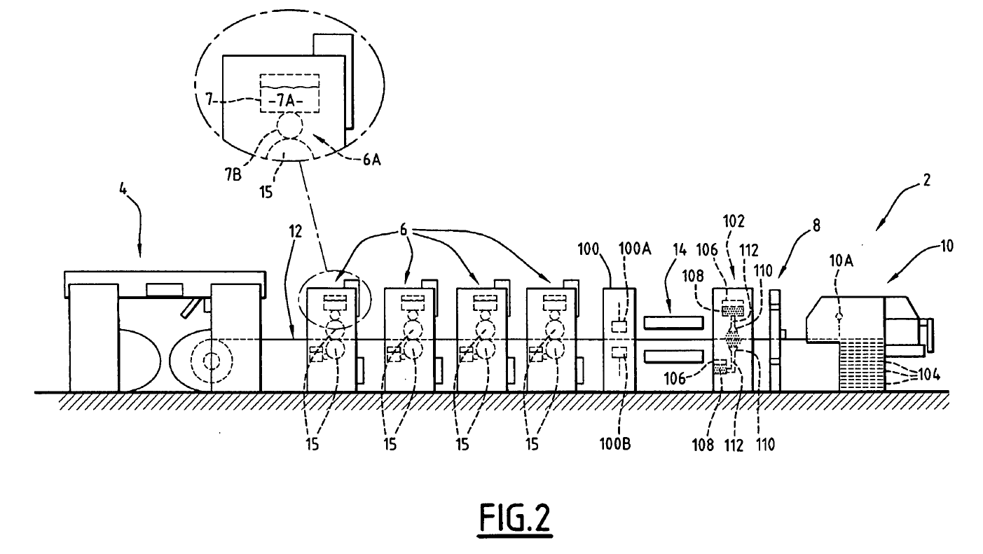

The printing machine 2 in the embodiment shown in FIG. 2 differs from the printing machine 2 shown in FIG. 1 in that an infrared dryer 14 is positioned between the capture device 100 and the traction device 8, the printed web 12 being taken through this dryer. The infrared dryer 14 can be replaced with another drying device operating by heating the web, such as a hot air dryer. The dimensions of the dryer 14 are smaller than those of prior art dryers.

The web capture device 100 is designed to detect a tear in the paper web 12 and to capture the free end of the paper web 12 if this occurs. For this purpose, the web capture device 100 has appropriate capture elements 100A. In a variant, the web capture device 100 is omitted.

The powdering device 102 is designed to deposit drying powder on each side of the printed web 12. It can deposit drying powder on one or both sides of the printed web 12. For this purpose, the powdering device 102 has a reservoir 106 containing powder 108 and a powdering head 110 joined to the powder reservoir 106 by a passage 112. The powdering device has a reservoir 106, a powdering head 110 and a passage 112 for each side of the paper web 12.

The powdering device 102 is designed to apply the drying powder to the paper web 12 continuously, preferably without interruption over a length equal to at least twice the length of a section 16 (see below). In particular, the powdering device 102 may deposit drying powder over a length equal to the length of the web 12 equal to the length of the web 12 for one print job. Thus the powdering device 102 has a simple structure and does not require timed control means.

The powder 108 used for powdering the web is preferably a powder containing silicone.

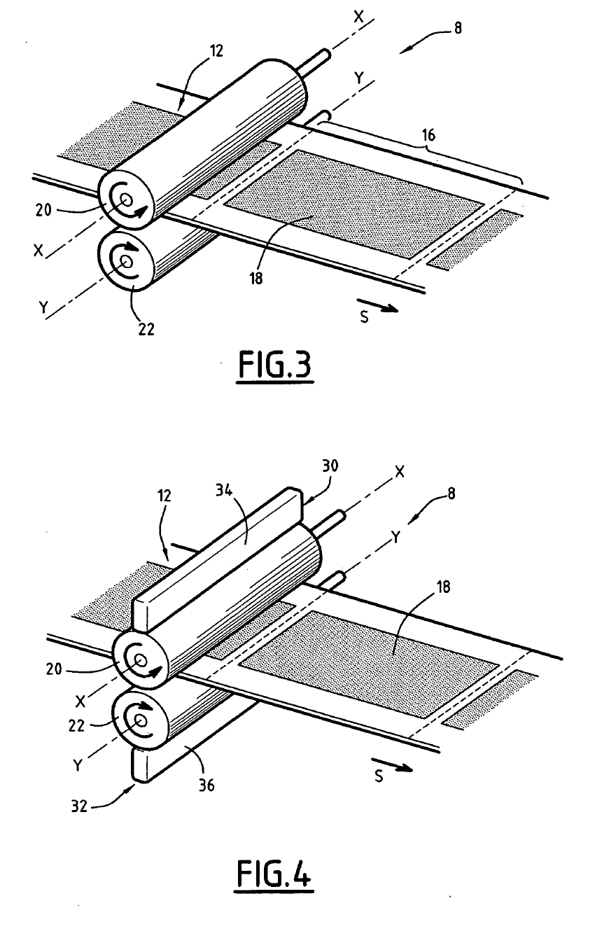

FIG. 3 is a perspective view of a detail of the traction device 8 according to the invention. The printed web 12 can be seen. The printed web 12 is composed of a sequence of web sections 16, each of which has the same length as a sheet cut off by the cutting and stacking device 10. Each section 16 also has an image 18 printed recto-verso by the printing rollers 15 of the printing units 6. Each section 16 also has an unprinted area in which no ink is present.

The traction device 8 has two traction rollers 20 and 22 which are made to rotate about their respective axes X-X and Y-Y. Each of the traction rollers 20 and 22 comes into contact with one of the surfaces of the printed web 12. The traction rollers 20 and 22 are driven in opposite directions, and their traction surface moves, at the point of contact with the web 12, in the same direction S as the printed web 12. Each of the traction rollers 20 and 22 has an outer surface whose circumference is identical to the length of the web section 16, which reduces marking. In a variant, the circumference is equal to an integer multiple of the length of the section 16.

The outer surface of each traction roller 20 and 22 is made from a material which repels the ink used for printing the images 18. For example, the traction rollers 20 and 22 have hydrophilic surfaces. One of the two rollers is covered with an elastomer. The generatrix at the contact between the two rollers forms a pinch for pulling the paper web 12. The surfaces of the two traction rollers 20 and 22 can, for example, be coated with a silicone-based compound.

The two traction rollers 20 and 22 are positioned facing each other, in such a way that the contact line between the traction roller 20 and the web 12 and the contact line between the traction roller 22 and the web 12 are located facing each other.

Advantageously, the circumferential velocity of the traction rollers 20 and 22 is slightly higher than the circumferential velocity of the printing rollers of the printing unit 6 located furthest downstream, in such a way that the printed web 12 is kept under traction and under a specified mechanical tension between the printing unit 6 and the traction device 8.

The traction device 8 enables a paper web to be printed and to be received in a cutting and stacking device 10, such as a flat sheet delivery device, without the need to dry this paper web 12 by evaporation of the ink solvents.

The image 18 is printed with the ink 7A contained in the ink reservoir 7. Advantageously, the ink 7A is a quick-drying ink, or a waterless ink, or a two-component ink. The drying of quick-drying inks is a combination of a first phenomenon known as “penetration into the substrate” and a second phenomenon known as “oxidizing polymerization of varnishes composed of oils and resins”.

Heat-set inks dry by evaporation of the mineral solvents mixed with the resin. UV inks dry by polymerization of the resin under the action of ultraviolet radiation.

Waterless inks are used with special printing plates on which non-printing areas can be defined without using the conventional lithographic process based on the rejection of the printer's black by a hydrophilic surface which has been moistened previously. These inks can be used in the same way as the conventional quick-drying inks mentioned above, making it possible to dispense with a dryer, or to design a smaller dryer.

FIG. 4 shows a detail of a second embodiment of a traction device 8, which differs from the embodiment of FIG. 3 in the following ways.

Similar elements are given the same references.

The traction module 8 also has two cleaning devices 30 and 32. The quality of the image 18 on the printed web 12 is thus improved further.

The cleaning devices 30 and 32 comprise cleaning bars 34 and 36 which are permanently in contact with the traction surface of the rollers 20 and 22. By way of example, each of the cleaning bars 34 and 36 can have a rotary brush placed in contact with the surface to be cleaned, or a strip of textile material brought into contact by a mechanical member. In both cases, cleaning is facilitated by the action of a solvent. These methods are used, in particular, for cleaning the blankets of rotary offset presses.

FIG. 5 shows a third embodiment of the traction device 8, viewed from the side. This embodiment differs from the second embodiment in the following ways.

The two traction rollers 20 and 22 have ink-repellent surfaces, such as coatings made from a silicone-based compound.

The cleaning device 30 has a cleaning roller 38 comprising a surface made from an ink attracting material, which is in contact with the surface of the traction roller 20. The cleaning roller 38 is, for example, coated with a porous ceramic which is designed to be impregnated with ink and thus has surface properties which promote the transfer of the ink. This method is used, in particular, to form ink rollers. The cleaning device 30 also has a doctor blade 42 which is permanently in contact with the surface of the cleaning roller 38 and which directs the ink collected by the roller 38 towards a recovery tank 46.

The cleaning device 32 has a cleaning roller 40 which comprises a surface made from an ink attracting surface, such as a coating of porous ceramic which is designed to be impregnated with ink, and thus has surface properties which promote the transfer of the ink. The surface of the roller 40 is in contact with the surface of the traction roller 22. The cleaning device 32 also has a doctor blade 44 which is permanently in contact with the surface of the cleaning roller 40 and which guides the ink collected by the roller 40 towards a recovery tank 48.

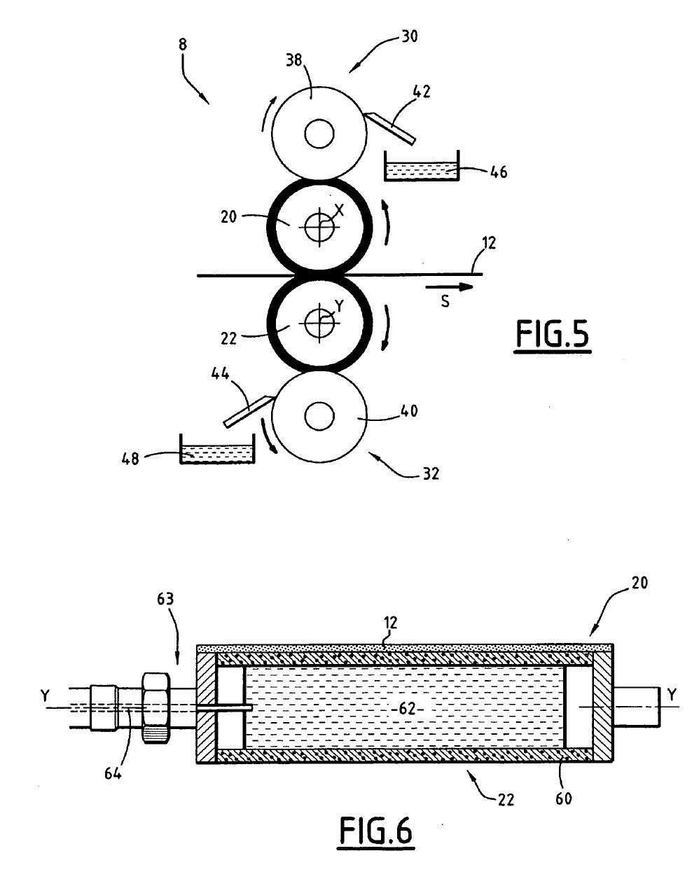

FIG. 6 shows a cross section through a traction roller of a fourth embodiment of a traction module 8 according to the invention. This traction module 8 has a traction roller 22 which is provided with a porous wall 60, forming a porous traction surface. The pores of the wall 60 are open cells, and consequently a liquid 62 placed inside the roller 22 can pass through the wall 60 and come into contact with the printed web 12. The liquid 62 is, for example, a mixture of water and silicone.

The traction roller 22 also has a rotary joint 63 comprising a central liquid supply device 64 which opens inside the traction roller 22. The supply device 64 is positioned coaxially with the axis Y-Y of the traction roller 22.

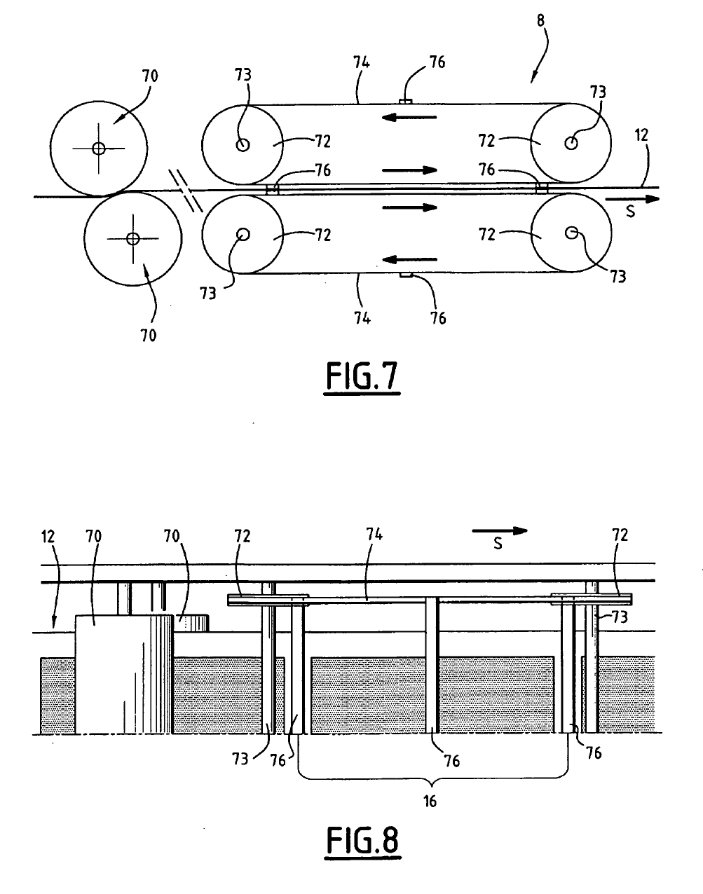

FIGS. 7 and 8 show a fifth embodiment of a traction device 8.

This traction device 8 has two blanket rollers 70 which bear on each side of the printed web 12 and which are offset from each other in the direction of the path of the web 12.

The traction device 8 also has eight toothed wheels 72 connected in pairs by shafts 73. The traction device 8 is provided with four belts or chains 74, each of which is guided around two toothed wheels 72 positioned on the same side of the web 12. The two belts 74 on one side of the printed web 12 are connected by traction bars 76, which are spaced apart from each other on the belt 74 by a distance equal to the web section 16. The traction bars 76 are designed to bear on each side of the web 12, facing each other, and to clamp the web between them. They are thus designed to exert a tractive force on the web 12.

The bars 76 are preferably driven in synchronization with the web 12 in such a way that they only bear on the unprinted area of the web 12. The surface of the bar 76 coming into contact with the web 12 is preferably made from elastomer.

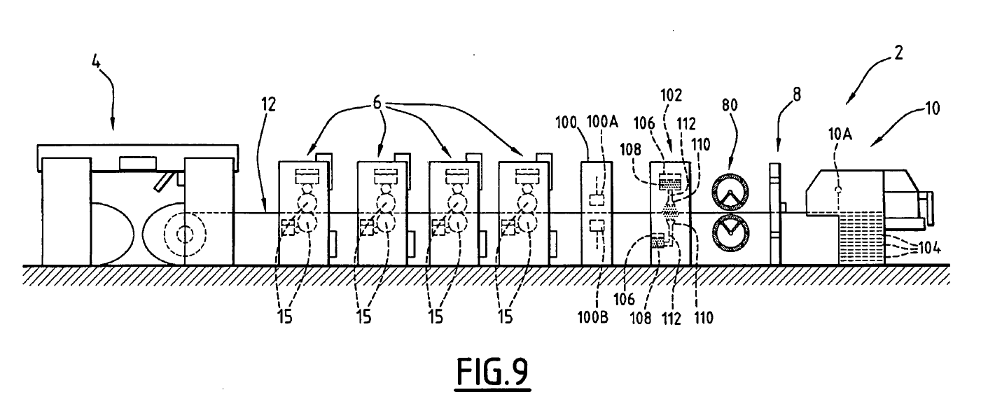

FIG. 9 shows part of a variant of a printing machine, having a support device 80 positioned between the printing unit 6 located furthest downstream and the cutting and stacking device 10. In this case, the support device 80 is positioned upstream of the traction device 8. This support device 80 has two support rollers 82 positioned one on each side of the web 12.

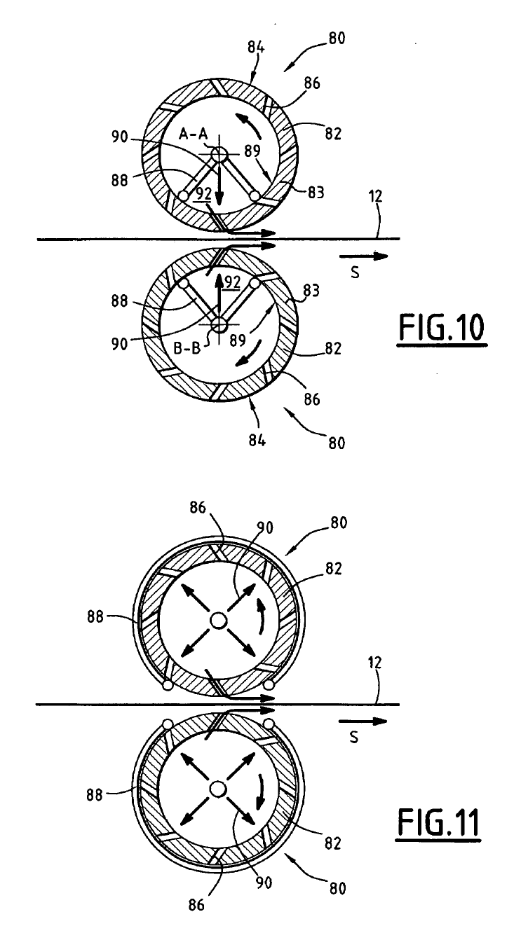

FIG. 10 shows an enlarged cross section of the support rollers 82.

The support rollers 82 are hollow and each has a cylindrical wall 83 of annular cross section. The wall 83 forms an outer support surface 84. The support device 80 has means for creating an air cushion between the support surface 84 and the printed web 12. These means for creating an air cushion have, on the one hand, openings 86 passing through the wall 83 of the roller 82. These openings 86 are positioned, in cross section, as secants with respect to the axis of rotation A-A, B-B of the roller 82. In the proximity of the web 12, the openings 86 also have a component lying in the direction of movement S of the web 12 and in the radially outward direction with respect to the axis of rotation A-A, B-B of the roller 82 in question. The air cushion creation means also comprise two sealing walls 88 positioned inside each support roller 82, these sealing walls bearing in an airtight way on the inner surface 89 of the wall 83 with their opposite sides on the central axis of the support roller 82. A pressurized air inlet 90 is also connected to the chamber 92 formed by the walls 83 and 88.

During the operation of this support device 80, the support rollers 82 are made to rotate in such a way that their circumferences in the proximity of the printed web move in the direction S of the path of the printed web 12. The opening 86 which is in communication at a given instant with the chamber 92 formed by the walls 83 and 88 allows the air in the chamber 92 to escape and to create an air cushion between the outer surface 84 and the printed web 12, thus guiding the printed web 12.

FIG. 11 shows a variant of the support device 80 which differs from the device of FIG. 10 in the following ways. Similar elements are given the same references.

This support device 80 has a single sealing wall 88 for each roller 82, extending around practically the whole circumference of the support roller 82 with the exception of a part facing the printed web 12. There is no sealing wall extending inside the roller 82. This embodiment is easy to produce.

In a variant which is not illustrated, at least one of the traction rollers 20 and 22 has openings in its outer surface, and the traction device 8 is provided with a vacuum device designed to create a vacuum in these openings. This helps to guide the web 12.

As a general rule, the traction elements have traction surfaces which come into contact with the unprinted area of the web 12 only. For this purpose, the traction elements can comprise a traction roller which bears on an unprinted lateral area of the web.

In yet another variant, the powdering device 102 is positioned downstream of the traction device 8.

It is also advantageous to position the dryer 14 upstream of the powdering device 102 in order to avoid the risk of degradation of the powder by the dryer 14.

What is claimed is:

1-26. (canceled)

27. A rotary printing machine comprising:
a continuous web of material to be printed on, the web having two sides, and
at least one printing unit designed to print on the web, and
a powdering device, designed to deposit powder on at least one of the two sides of the web printed by the printing unit.

28. The printing machine according to claim 27 further comprising a cutting device designed to cut the web printed by the printing unit into sheets, the powdering device being positioned upstream of the cutting device.

29. The printing machine according to claim 28 further comprising a stacking device designed to stack the sheets produced by the cutting device.

30. The printing machine according to claim 29 further comprising a traction device located downstream of the printing unit located furthest downstream and upstream of the cutting device, and the traction device is designed to apply a specified mechanical tension to the printed web emerging from the printing unit located furthest downstream.

31. The printing machine according to claim 30 wherein the powdering device is positioned downstream of the traction device.

32. The printing machine according to claim 30 wherein the powdering device is positioned upstream of the traction device.

33. The printing machine according to claim 30 wherein the machine is designed to convey the printed web in a freely suspended way in an ambient atmosphere along the whole path between the printing unit located furthest downstream and the powdering device, and between the powdering device and the traction device.

34. The printing machine according to claim 30 further comprising a web capture device positioned directly downstream of the printing unit located furthest downstream, and it is designed to convey the printed web in the ambient atmosphere along the whole path between the printing unit located furthest downstream and the web capture device.

35. The printing machine according to claim 27 further comprising a device for drying the printed web positioned upstream of the powdering device.

36. The printing machine according to claim 32 wherein the machine is designed to convey the printed web in the ambient air along the whole path between the traction device and the cutting device.

37. The printing machine according to claim 30 wherein the traction device has two traction elements, each having a traction surface designed to contact one side of the printed web in order to apply the specified mechanical traction to this printed web.

38. The printing machine according to claim 37 wherein the machine has a supply for an ink-repellent liquid, the supply connected to deliver the liquid to at least one traction surface.

39. The printing machine according to claim 37 wherein the two traction elements have ink-repellent traction surfaces.

40. The printing machine according to claim 37 wherein the two traction elements are traction rollers.

41. The printing machine according to claim 40 wherein the two traction rollers are positioned facing each other.

42. The printing machine according to claim 37 wherein each of the two traction elements is designed to come into contact with one of the two opposite sides of the printed web.

43. The printing machine according to claim 40 wherein the traction device is provided with a device for cleaning the traction surface of at least one of the traction rollers.

44. The printing machine according to claim 43 wherein the cleaning device has a cleaning bar in contact with the traction surface.

45. The printing machine according to claim 37 wherein the traction elements have traction bars extending across the printed web.

46. The printing machine at least according to claim 28 further comprising a support device positioned between the printing unit located furthest downstream and the cutting device, the support device having at least one support roller provided with a surface for supporting the printed web, and the support device having a device for creating an air cushion between the support surface and the printed web.

47. The printing machine according to claim 27 wherein the web is a web of coated paper.

48. The printing machine according to claim 47 wherein the coated paper of the web is coated paper having a coat of kaolin or chalk.

49. The printing machine according to claim 27 wherein the printing unit comprises an ink reservoir containing ink adapted for printing on the web.

50. The printing machine according to claim 49 wherein the ink is waterless ink.

51. The printing machine according to claim 49 wherein the ink is quick-drying ink or two-component ink.

52. A printing method for a printing machine as recited in claim 17 comprising the following steps:
printing on a web to form a printed web;
applying a drying powder to the printed web; and
cutting the printed web into printed sheets.
